(19) United States
(12) Patent Application Publication
(10) Pub. No.: US 2023/0391894 A1
(43) Pub. Date: Dec. 7, 2023

(54) PROCESS FOR OBTAINING NATURAL RUBBER, RUBBER COMPOSITION CONTAINING NATURAL RUBBER AND USE THEREOF

(71) Applicants: Continental Reifen Deutschland GmbH, Hannover (DE); Fraunhofer Gesellschaft zur Förderung der angewandten Forschung e.V., München (DE)

(72) Inventors: Carla Recker, Hannover (DE); Katharina Herzog, Harsum (DE); Frank Behm, Sassen-Trantown (DE); Norbert Janczak, Gützkow (DE); Carsten Venz, Neddemin (DE); Lowis-Gerrit-Boje Müller, Rheine (DE); Dirk Prüfer, Münster (DE); Christian Schulze Gronover, Münster (DE)

(73) Assignees: Continental Reifen Deutschland GmbH, Hannover (DE); Fraunhofer Gesellschaft zur Förderung der angewandten Forschung e.V., München (DE)

(21) Appl. No.: 18/246,388

(22) PCT Filed: Sep. 14, 2021
(86) PCT No.: PCT/EP2021/075151

§ 371 Date: Mar. 23, 2023

(30) Foreign Application Priority Data
Sep. 23, 2020 (DE) 10 2020 211 872.

(51) Int. Cl. C08C 1/15; C08C 3/02; C08C 1/06; C08L 7/00; C08K 13/02

(52) U.S. Cl. CPC C08C 1/15; C08C 3/02; C08K 3/04; C08L 7/00; C08K 13/02; C08C 1/06

(57) ABSTRACT

The present invention relates to a process for obtaining aging-resistant natural rubber, to a rubber composition comprising the thus-obtained natural rubber and to the use of this composition for producing consumer goods.

The present invention relates to a process for obtaining aging-resistant natural rubber, to a rubber composition comprising the thus-obtained natural rubber and to the use of this composition for producing consumer goods.

Many consumer goods of everyday modern life are made of rubber. With regard, here, to possible stress and quality, natural rubber is often superior to synthetically produced rubber. For a long time, natural rubber was mainly obtained from rubber trees of the genus Hevea, in particular from Hevea brasiliensis, a plant species mainly cultivated in Asia.

Recently, searches have been made for suitable alternatives for obtaining rubber, with particular interest in plants that also thrive under the climatic conditions of Central Europe. A known suitable alternative for obtaining natural rubber is the dandelion (Taraxacum sp.), especially the Russian dandelion (Taraxacum kok-saghyz, or Taraxacum koksaghyz); in addition, a natural rubber very similar to that from Hevea species can also be obtained from guayule (Parthenium argenatatum).

Natural rubber from Hevea is known to contain a relatively high proportion of proteins and other cellular constituents or biomolecules in addition to the rubber polymers. Said constituents, which come from the original plant, give the natural rubber good quality and natural stabilization against aging, but some of these constituents are also known to trigger allergies in humans.

In the case of synthetic rubber, which is usually free of proteins and other cellular constituents, the addition of aging stabilizers is customary and a multitude of suitable aging stabilizers are known. Examples of suitable aging stabilizers are described in DE19818564A1, US2010063189A, US2011303338A, EP3181628A1, WO19057703 and EP3524639A1.

In addition, U.S. Pat. No. 4,568,711 discloses a synergistic combination of two antioxidants for natural rubber obtained from guayule.

It is an object of the present invention to provide a process by means of which aging-resistant natural rubber can be produced.

This object is achieved by a process as claimed in claim 1, the dependent claims specifying preferred embodiments. Elastic products having high load-bearing capacity, for example vehicle tires, can be produced from the natural rubber obtained in this way.

The process described here is a process for obtaining aging-resistant natural rubber, in which, at an early point while the natural rubber is being obtained from the plants, an aging stabilizer is contacted with the plant sap obtained or its ingredients (which have been optionally removed beforehand and optionally already purified), in particular with the natural polyisoprenes, before the natural rubber has been (completely) dried.

Accordingly, the process comprises a step (I) in which a plant material is provided that contains a polymer-containing sap, wherein said sap contains at least natural polyisoprenes, in particular cis-1,4-polyisoprenes.

“Plant material” is understood to mean an entire plant of a genus described here, multiple plants of a genus described here, multiple plants of different genera described here, a part of a plant of a genus described here or multiple parts of a plant of a genus described here, a part of plants of multiple genera described here (e.g. root or leaves from each plant) or multiple parts of plants of multiple genera described here.

“Sap” is understood according to the present description to mean any liquid that is present in the plant material, or that escapes from the plant material with mechanical, thermal or chemical treatment, can be squeezed out, can be extracted, or can be removed from the solid plant material in some other way. “Sap” always contains—besides water—at least one, preferably a plurality of ingredients typical of the plants. Sap containing natural polyisoprenes as polymers is used for application in the process according to the invention. Polyisoprene-containing plant material is therefore involved.

According to step (II), this polymer-containing sap or at least its ingredients, in particular the natural polyisoprenes, is obtained from the plant material (also referred to here as extraction). The natural rubber contained in the sap can have already been coagulated in the plant material before extraction. The extraction of the sap and/or its ingredients can be done in any suitable manner that makes it possible for the sap contained in the plant material and/or its ingredients, in particular at least a preferred part of the ingredients, such as the natural polyisoprenes, to escape from the plant material and to be obtained therefrom. Extraction processes for obtaining the sap and/or its ingredients, in particular the natural polyisoprenes, can comprise at least one of the following process steps: comminuting the plants or plant parts, crushing the plant material, disrupting the plant material by mechanical, chemical or thermal treatment, squeezing the plant material, heating the plant material and/or the sap and/or its ingredients, admixing the plant material/sap and/or its ingredients with an aqueous solution, admixing the plant material with spores of a fungus that decomposes the plant material, in particular Phytophthora infestans, admixing the plant material/sap and/or its ingredients with at least one chemical compound, preferably an organic acid, aerobically or anaerobically fermenting the plant material and/or separating solids and liquid phase. However, it is preferred that the plant material/the sap and/or its ingredients are not admixed with an enzyme before the natural polyisoprenes are coagulated; preferably, no enzyme is added to the preparation throughout the process of obtaining polyisoprenes described here.

Processes for obtaining sap and/or its ingredients are known in principle; for example, suitable processes are described in US2007276112A, WO11139382A2, DE102013107279A1, US2016237254A, EP3371229A1, DE2017118163A1, WO18036825A1 and WO18064484A1.

The natural polyisoprene can be either cis-1,4-polyisoprene or trans-1,4-polyisoprene. Natural rubber is preferentially mainly cis-1,4-polyisoprene, with the proportion of cis-1,4 in the natural rubber polymers commonly being greater than 99% by weight.

According to step (III) of the invention, the sap obtained and/or its ingredients, in particular the natural polyisoprenes, is/are contacted with at least one aging stabilizer. Here, the contacting of the sap and/or its ingredients with the aging stabilizer can be achieved by the plant material already being in contact with the aging stabilizer before extraction, for example by placing the plants in an aqueous solution or water, either of which contains the aging stabilizer, by wetting the plants with the aging stabilizer in liquid form, or by adding the aging stabilizer as a solid to the plant material before said plant material is disrupted. Alternatively, the aging stabilizer can be added in solid, liquid or dissolved form during the disruption of the plant material, for example by mechanical, chemical or thermal processing of the plant material. Alternatively, the aging stabilizer can also be contacted with the sap and/or its ingredients after it has/they have escaped from the plant material. A later addition of the aging stabilizer to the sap and/or its ingredients is possible too, for example before, during or after the below-described process step (IV), or before or during the below-described process step (V), but, according to the invention, before the natural rubber has been dried. Therefore, according to the invention, the natural rubber obtained from the plant material has already been contacted with aging stabilizer(s) before drying and/or during drying at the latest, i.e. is admixed with aging stabilizer during drying. It is preferred that the aging stabilizer has been contacted with the natural rubber before drying. According to the process of the invention, it is particularly preferred if the aging stabilizer(s) come(s) into contact with the sap and/or its ingredients, in particular with the natural polyisoprenes, as early as possible after the plant material has been disrupted, in order for the polymers contained in the sap to be protected as effectively as possible from the influence of atmospheric oxygen and other environmental conditions beyond the plant material.

Step (IV) of the process comprises the coagulation and/or agglomeration of the polymers contained in the sap, in particular the natural polyisoprenes. Here, the coagulation or agglomeration can be achieved by any coagulation or agglomeration process known in the art, in particular by any of the known coagulation or agglomeration processes for rubber. It is preferred that the coagulation/agglomeration of the polyisoprenes takes place in an aqueous solution. This can also mean that the coagulation/agglomeration can already take place in the sap still present in the plant material, for example if the plant material is being stored or thermally treated, for example by boiling. The coagulation or agglomeration of the polymers can also take place during the treatment of the plant material to extract the sap and/or its ingredients, for example by heating to disrupt the plant material or heating the escaping sap, so that step (IV) does not require a separate addition of a substance and/or does not require a separate additional procedure. Without being limited thereto, suitable processes for coagulating/agglomerating the polymers are, for example, heating the plant material/the sap, adding ions, adding organic solvents, etc.

As a result of the coagulation or agglomeration of the polymers, the polymer chains originally previously dissolved and/or emulsified in the sap change to a solid state and can be removed from the (preferably aqueous) mixture. Preferably, according to the invention, the polyisoprenes are coagulated by storing or heating the plant material/the sap, preferably as far as boiling in water or an aqueous solution. When heated, the polyisoprenes contained in the sap flocculate and the resulting natural rubber flakes can be removed from other constituents of the plant material and the sap. Without being limited to the processes mentioned, any suitable separation process can be used to remove the rubber flakes, for example skimming, sieving, filtering, milling, drawing off the liquid phase, centrifugation, etc.

The natural rubber flakes obtained in this way can be washed in one or more intermediate steps according to step (V) in order to additionally purify the natural rubber obtained to remove other ingredients of the plant material. To this end, the natural rubber flakes obtained can be contacted with fresh water or an aqueous solution, for example transferred thereinto. According to the invention, step (III), i.e. the addition of the aging stabilizer, can also take place before, during or after such a washing step, for example by adding the aging stabilizer to the water/the aqueous solution with which the natural rubber flakes are contacted in the washing step(s). Preferably, the rubber flakes are slurried, or suspended or dispersed, for example by stirring or shaking or by rotation in a rotary drum, in the water/the aqueous solution.

In step (VI) of the process, the coagulated or agglomerated natural rubber particles (flakes) are obtained from the aqueous mixture/suspension or dispersion. At this point, “obtaining” means that no additional washing or purification step follows the removal of the natural rubber flakes from the liquid phase. Here too, the invention is not limited to a particular method of removing the solid particles from the aqueous mixture/suspension or dispersion; instead, any suitable separation process can be used, for example skimming, sieving, filtering, drawing off the liquid phase, centrifugation, etc.

As a result of the removal of the natural rubber particles (flakes) from the liquid phase of the aqueous mixture/suspension or dispersion according to steps (V) and (VI), they are at least partially, preferably extensively, removed from other ingredients of the plant material, so that the natural rubber obtained contains other ingredients of the plant material, in particular other ingredients of the sap, only in an amount of up to a maximum of 30% by weight, preferably of up to a maximum of 25% by weight, further preferably of up to a maximum of 20% by weight, yet further preferably of up to a maximum of 15% by weight. It should be noted here that the ingredients of the original sap may be depleted to different extents, for example the inulin occurring in a large proportion in the original sap is preferentially substantially removed (washed out) from the natural rubber flakes, whereas proteins, for example, can themselves flocculate to some extent as well during the heating process and can likewise be removed from the aqueous solution when obtaining the rubber flakes. It is definitely preferred that the natural rubber obtained has at least a certain content of other natural ingredients originating from the plant material, for example oligomeric isoprenoids, lipids and proteins, in addition to the natural polyisoprenes.

The natural rubber obtained from the mixture, suspension or dispersion is optionally dried by means of a suitable process for further processing. Suitable processes for drying natural rubber are known in the art and, without being limited thereto, can include air and/or heat treatment. According to the process of the invention, the aging stabilizer is already in contact with the natural rubber during drying at the latest, preferably even before this step.

If the aging stabilizer(s), during or after the abovementioned process steps, should still be insufficiently distributed or incorporated in the natural rubber obtained, this can be achieved by further incorporation of the aging stabilizers(s) into the natural rubber during the process, in particular before, during or after step (IV), during or after (at least one of the) washing step(s) according to step (V), or else after step (VI) or after drying the rubber, for example by stirring, kneading, milling, by diffusion in a suspension of natural rubber and aging stabilizer in water or another suitable process. Said “further incorporation” does not refer to the addition/contacting of the aging stabilizer, but to the even distribution and incorporation of the agent in the natural rubber material. As already mentioned above, the contacting of the aging stabilizer with the sap/its ingredients always takes place before the (complete) drying of the natural rubber. The temperature during the contacting of the aging stabilizer into the natural rubber is preferably selected in a range from −25° C. to 100° C., preferably in the range from 0° C. to 90° C., particularly preferably from 10° C. to 80° C. The time should be at least 10 min, preferably at least 30 min, further preferably at least 1 hour, and can, if necessary, be extended as desired up to a suitable period of time; for example, the contacting can be between 1 hour and 7 days, preferably 2 hours to 3 days, further preferably from 4 hours to 36 hours, yet further preferably from 4 to 10 hours, in order to ensure an efficient activity of the aging stabilizer even before the (complete) drying of the natural rubber.

The present process according to the invention was described above with reference to the process steps which occur or can occur in the process according to the invention. However, it should be noted here that some of the process steps can be carried out simultaneously or coincide, that individual steps can be repeated, and that the steps also do not necessarily have to be carried out in the designated order. However, it is preferred according to the invention that steps (I) to (VI) are all carried out before the drying of the natural rubber according to step (VII). In a preferred embodiment of the process, at least some, preferably all, of the steps described as optional in the claim or in the above description are likewise carried out. Particular preference is given to carrying out the washing step(s) (V) of the process. In a preferred embodiment in which the washing is carried out, during at least one of these washing step(s), at least some of the aging stabilizer to be incorporated into the natural rubber is added to the fresh water used for washing the natural rubber flakes. The drying step (VII) is also preferably carried out as a separate process step.

The incorporation of the aging stabilizer(s) according to step (VIII) is likewise preferably carried out, it being possible for such incorporation to take place before the drying of the natural rubber, during or after the drying thereof, or both before and during/after the drying of the natural rubber. The incorporation of the aging stabilizer(s) into the natural rubber can thus still be carried out in the aqueous mixture/suspension of the natural rubber flakes, after the removal of the liquid phase from the natural rubber flakes, but before the actual drying, or else during or after the drying, or both. Preference is given to carrying out the incorporation of the aging stabilizer(s) by stirring, milling, kneading, by diffusion in a suspension of natural rubber and aging stabilizer in water or any other suitable process for a period of time that allows efficient incorporation into the finished (dried) natural rubber.

In principle, the process according to the invention can be applied to all plant species suitable for obtaining natural rubber. Besides Hevea brasiliensis, examples of such plants include members of the Asteraceae, such as Taraxacum sp. or Scorzonera sp., in particular Taraxacum kok-saghyz, Taraxacum krim-saghyz, Taraxacum bicome, Taraxacum brevicomiculatum, or Scorzonera tau-saghyz, Scorzonera uzbekistanica, Scorzonera teke-saghyz, Scorzonera hispanica, Scorzonera tausaghyz, or guayule (Parthenium argentatum), or else other species such as Apocynum venetum, Asclepias incamata, Asclepias cornuti, Asclepias sub-lata, Asclepias syrica, Cacalia atriplicifolia, Campanula America, Chicorium intybus, Chondrilla ambigua, Chondrilla pauciflora, Crysothamnus nauseousus, Cryptostegia grandiflora, Euphorbia lathyris, Lactuca serriola, Lactuca sativa, Parthenium incanum, Pycnanthemum incanum, Solidago altissima, Solidago graminifolia, Solidago leavenworthii, Solidago rigida, Sonchus arvensis, Sonchus oleraceous, Teucreum canadense, or Silphium sp., or mixtures of these plants and also naturally occurring or cultivated hybrids of the aforementioned species.

According to the invention, the plant material from which the sap and/or its ingredients is/are obtained can be especially a plant species or a mixture of plant species that thrive under the climatic conditions of Central Europe and contain natural polyisoprenes in their saps.

The plants or plant parts are preferably introduced into the process as fresh plant material, optionally after a certain storage period, for example of up to 1 year, but without separate drying of the plants or of the plant material used. It is therefore preferred according to the invention that the plant material, when processed according to the process described here, still contains at least 10%, preferably at least 25%, further preferably at least 40%, 50%, 60%, 70%, 80%, 90% or even 95% of the moisture that it had when harvested. However, it is also possible to use plant materials which—for example after storage—have a relatively low moisture content, for example a moisture content<10%, <5%, <3%, <2% or <1%.

According to the invention, the plant(s) is/are preferably selected from a Taraxacum sp. or a Scorzonera sp., especially from Russian dandelion, such as Taraxacum kok-saghyz, Taraxacum krim-saghyz, Taraxacum bicome, Taraxacum brevicorniculatum, or from Scorzonera tau-saghyz, Scorzonera uzbekistanica, Scorzonera teke-saghyz, Scorzonera hispanica, Scorzonera tausaghyz, or mixtures of these plants, preferably from Taraxacum kok-saghyz, Scorzonera tau-saghyz, Scorzonera uzbekistanica, Scorzonera teke-saghyz or mixtures or hybrids thereof, particularly preferably from Taraxacum kok-saghyz or from Scorzonera tau-saghyz. However, according to the present invention, it is particularly preferred to obtain the natural rubber from a dandelion species (Taraxacum species), especially from Russian dandelion, preferably from Taraxacum kok-saghyz or Taraxacum krim-saghyz, particular preference being given to Taraxacum kok-saghyz. Hybrids involving Taraxacum kok-saghyz or Taraxacum krim-saghyz are particularly suitable, too. For the process according to the invention, the plant material used can also be just a part of whole plants, in particular a part in which the concentration of natural polyisoprenes is particularly high, for example the roots of the plant in the case of dandelion.

The aging stabilizer used can, in principle, be any known aging stabilizer. The aging stabilizer is preferably selected from an antioxidant, a metal-ion complexing agent and/or a free-radical scavenger, it also being possible for various aging stabilizers to be used as a mixture or in combination.

Preferably, the aging stabilizer is selected from butylated hydroxytoluene (BHT), vitamin E in at least one stereoisomeric form or a derivative thereof, an N—C₁₋₁₂-alkyl-N′-phenyl-p-phenylenediamine, such as N-isopropyl-N′-phenyl-p-phenylenediamine, N-1,3-dimethylbutyl-N′-phenyl-p-phenylenediamine (6PPD), N-1,4-dimethylpentyl-N′-phenyl-p-phenylenediamine (7PPD) or N,N′-bis-1,4-(1,4-dimethylpentyl)-p-phenylenediamine (77PD), diaryl-p-phenylenediamine (DTPD), 4,4′-bis(C₁₋₁₂-alkylamino)triphenylamine, 7,8-dimethylisoalloxazine or a compound containing 7,8-dimethylisoalloxazine as a structural building block, such as riboflavin, p-phenylenediamine, p-di(nitroso)arenes, such as poly-p-di(nitroso)benzene, oligomerized 2,2,4-trimethyl-1,2-dihydroquinoline (TMQ), styrenated diphenylamine (DDA), cumylated diphenylamine, zinc salt of 4- and 5-methylmercaptobenzimidazole, 2,6-di-tert-butylphenol, 2,6-di-tert-butyl-4-ethylphenol, 2,2′-methylenebis(6-tert-butyl)-p-cresol, poly(dicyclopentadiene-co-p-cresol), n-octadecyl beta-(4-hydroxy-3,5-di-tert-butylphenyl)propionate, 2,2′-methylenebis(4-methyl-6-tert-butylphenol) (BPH), 2-methyl-4,6-bis(octylsulfanylmethyl)phenol, thiobisphenols, 4,4′-bis(1,1-dimethylbenzyl)diphenylamine (CDPA), octylated diphenylamine (ODPA), phenyl-a-naphthylamine (PAN), phenyl-beta-naphthylamine (PBN), tris(nonylphenyl)phosphite, sodium hypophosphite, 2,2,4-trimethyl-1,2-dihydroquinoline (TMQ), 2-mercaptobenzimidazole (MBI), methyl-2-mercaptobenzimidazole (MMBI), or any combination of the foregoing. Preferably, the aging stabilizer(s) is/are selected from butylated hydroxytoluene (BHT), vitamin E in the form of a tocopherol or a tocotrienol, in particular desmethyl-tocotrienols, gamma-tocotrienol, delta-tocotrienol or a mixture of gamma- and delta-tocotrienol (e.g. “DMT3” from Tricutis), the zinc salt of di-n-butyldithiocarbamic acid, one of the abovementioned phenylenediamines, and a mixture of butylated reaction products of p-cresol and dicyclopentadiene according to formula (I) with n=1, 2, 3, 4, 5, 6, 7, 8 or 9 (e.g. the product sold under the name Wingstay® L by Omnova Solutions).

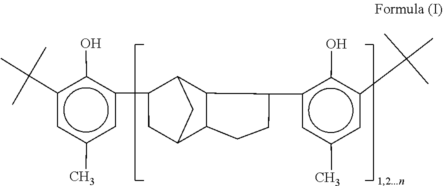

Further preferably, the aging stabilizer(s) is/are selected from butylated hydroxytoluene (BHT), vitamin E in the form of a tocopherol or a tocotrienol, in particular desmethyl-tocotrienols, gamma-tocotrienol, delta-tocotrienol or a mixture of gamma- and delta-tocotrienol (e.g. “DMT3” from Tricutis), and a compound according to formula (I) with n=1, 2, 3, 4, 5, 6, 7, 8 or 9 (e.g. Wingstay® L from Omnova Solutions), yet further preferably from BHT or a compound according to formula (I), in particular Wingstay® L from Omnova Solutions. Particularly preferably, the aging stabilizer used is at least butylated hydroxytoluene (BHT), optionally in combination with another of the foregoing. If a mixture is used, a preferred mixture is BHT with a vitamin E in the form of a tocopherol or a tocotrienol and/or with the compound according to formula (I), in particular Wingstay® L from Omnova Solutions.

The amount of aging stabilizer(s) used is calculated in such a way that the aging stabilizer(s) is/are available on contact with the polymer-containing sap in an amount which results in a total amount of aging stabilizer(s) in the finished (dried) natural rubber of at least 0.01 phr, preferably an amount of from 0.05 to 5 phr, further preferably from 0.10 to 3.5 phr, particularly preferably from 0.25 to 2 phr, most preferably from 0.4 to 1 phr, based on the finished, dried rubber.

The unit “phr” (parts per hundred parts of rubber by weight) used here is the conventional indication of quantity for mixture recipes in the rubber industry. The dosage of the parts by weight of the individual substances is always based here on 100 parts by weight of the total mass of all rubbers present in the mixture.

The aging stabilizer can be added to the plant material/the sap/its ingredients in any suitable form. Depending on the state of matter of the aging stabilizer as such, it can be added to the plant material/the polymer-containing sap and/or its ingredients in the form of a powder, a suspension, a liquid or a solution. It is particularly preferred here that—should the aging stabilizer as such be a solid—the aging stabilizer is very finely ground before coming into contact with the sap, is suspended in a liquid, or is dissolved in a suitable organic or aqueous solvent. If the aging stabilizer is finely ground, preference is given to it having a maximum particle size of 1000 μm. If the aging stabilizer is dissolved, preference is given to using an aqueous solvent or a suitable organic solvent. If an aqueous solvent is used, water or, for example, an aqueous buffer can be used, and what is preferred as an organic solvent is ethanol, isopropanol or process oil (vegetable or mineral-based oils). A mixture of suitable aqueous and organic solvents can be used, too. If an organic solvent is used because an aging stabilizer is insoluble in water, the aging stabilizer may crystallize out again when added to the aqueous system used for obtaining or purifying natural rubber. If the aging stabilizer itself is present as a pure substance in the form of a liquid, it can also be used directly in this form or, if necessary, diluted with another suitable liquid, for example with one of the aforementioned solvents.

The natural rubber obtained from the sap and admixed with aging stabilizer can be used to produce a rubber composition from which rubber articles can be produced.

Besides the ingredients originating from the natural source of the natural rubber, further ingredients may be added to the rubber composition in order to make the composition particularly suitable for the intended processing purpose. Therefore, at least one of the following ingredients may be added to a rubber composition according to the invention:
(i) Further types of rubber selected from natural rubber or synthetic rubber
(ii) Fillers, preferably carbon black and/or silica
(iii) Plasticizers
(iv) Activators
(v) Adhesives
(vi) Pigments
(vii) Vulcanization accelerators
(viii) Vulcanization retarders
(ix) Further crosslinking agents
(x) Other admixtures

All of these additives are well known in the technical field of rubber production. The rubber mixture may also additionally contain further ingredients (further aging stabilizers, processing aids, coupling agents, reinforcer resin systems, . . . )

The natural rubber produced by the present process may be used alone or in a rubber mix for the production of rubber articles. Preferred rubber articles are those that withstand mechanical stress and are elastic at the same time. Such articles are preferably selected from tires, in particular vehicle tires, or tire parts, bellows, conveyor belts, air springs, belts, drive belts, such as V-belts, toothed belts, flat belts, V-ribbed belts, hoses, footwear soles, rubber rings, medical articles and tubing.

For the production of tires, the rubber composition may optionally contain at least one further type of rubber in addition to the natural polyisoprene. It may be selected from the group consisting of natural polyisoprene and/or synthetic polyisoprene and/or epoxidized polyisoprene and/or butadiene rubber and/or butadiene-isoprene rubber and/or solution-polymerized styrene-butadiene rubber and/or emulsion-polymerized styrene-butadiene rubber and/or styrene-isoprene rubber and/or liquid rubbers having a molecular weight Mw of greater than 20 000 g/mol and/or halobutyl rubber and/or polynorbornene and/or isoprene-isobutylene copolymer and/or ethylene-propylene-diene rubber and/or nitrile rubber and/or chloroprene rubber and/or acrylate rubber and/or fluoro rubber and/or silicone rubber and/or polysulfide rubber and/or epichlorohydrin rubber and/or styrene-isoprene-butadiene terpolymer and/or hydrogenated acrylonitrile-butadiene rubber and/or hydrogenated styrene-butadiene rubber. Preferably, it is selected from other types of natural rubber, for example natural rubber from Hevea brasiliensis, synthetic polyisoprene and/or butadiene rubber and/or solution-polymerized styrene-butadiene rubber and/or emulsion-polymerized styrene-butadiene rubber. Said synthetic rubbers may optionally also be functionalized by suitable groups. A rubber mixture of this kind is particularly suitable for the production of pneumatic vehicle tires, in particular their treads, that are environmentally friendly and have low rolling resistance.

Possible additional rubber components in the production of industrial rubber articles, such as bellows, conveyor belts, belts, drive belts and hoses, and for footwear soles are, in particular, nitrile rubber, hydrogenated acrylonitrile-butadiene rubber, chloroprene rubber, butyl rubber, halobutyl rubber or ethylene-propylene-diene rubber. Said industrial rubber articles are used everywhere in everyday life, for example in elevators, in the automotive industry, in the raw materials industry, in the food industry and in medical technology.

If a rubber mix is used for the production of a rubber article, then it is preferred that said rubber mix contains the natural rubber containing natural polyisoprene and produced by the process according to the invention, in amounts of from 0.1 to 99 phr, preferably 0.5 to 90 phr, particularly preferably in amounts of from 5 to 85 phr. A further type of rubber that may be used is either a further natural rubber, for example a natural rubber from Hevea brasiliensis, or else a synthetic rubber, such as preferably a butadiene rubber and/or styrene-butadiene rubber, which may optionally be hydrogenated. However, it is also possible according to the invention for the rubber used for the rubber composition to contain only the natural rubber produced by the process according to the invention, i.e. to consist of it (up to 100 phr).

To produce a rubber article, the described polymers in the rubber composition can be at least partially covalently bonded to one another via a crosslinker (in any combination of natural and synthetic rubber with one another). This means that a crosslinker forms a covalent bond with at least two polymer strands, so that said polymer strands are covalently bonded to one another via the crosslinker. Crosslinking agents suitable for this purpose are known in the art.

If conventional vulcanization is carried out, the vulcanization of the rubber composition can be carried out in the presence of sulfur and/or sulfur donors with the aid of vulcanization accelerators, it being possible for some vulcanization accelerators to act simultaneously as sulfur donors. The accelerator may be selected from the group consisting of thiazole accelerators and/or mercapto accelerators and/or sulfenamide accelerators and/or thiocarbamate accelerators and/or thiuram accelerators and/or thiophosphate accelerators and/or thiourea accelerators and/or xanthogenate accelerators and/or guanidine accelerators and/or morpholine derivatives. Preference is given to using a sulfenamide accelerator selected from the group consisting of N-cyclohexyl-2-benzothiazolesulfenamide (CBS) and/or N,N-dicyclohexylbenzothiazole-2-sulfenamide (DCBS) and/or N-tert-butyl-2-benzothiazylsulfenamide (TBBS).

The sulfur donor substances used may be any sulfur donor substances known to those skilled in the art.

Further network-forming systems as obtainable, for example, under the trade names Vulkuren®, Duralink® or Perkalink® or network-forming systems as described in WO 2010/049216 A2 may be used in the rubber composition, too.

The rubber composition also preferably contains at least one filler such as silica, carbon black and optionally further known polar and/or nonpolar fillers, such as aluminosilicates and other silicates, chalk, kaolin, starch, magnesium oxide, zinc oxide, clay minerals such as bentonite, titanium dioxide and/or rubber gels, and also fibers (e.g. aramid fibers, glass fibers, carbon fibers, cellulose fibers), carbon nanotubes (CNTs, including discrete CNTs, so-called hollow carbon fibers (HCFs) and modified CNTs containing one or more functional groups, such as hydroxyl, carboxyl and carbonyl groups) and/or graphite and/or graphenes and/or so-called “carbon-silica dual-phase filler”.

If the filler is at least one silica, the rubber composition contains preferably 1 to 300 phr, particularly preferably 1 to 200 phr and most preferably 1 to 180 phr of at least one silica.

If the filler is at least one carbon black, the rubber composition contains preferably 1 to 200 phr, particularly preferably 1 to 170 phr and most preferably 1 to 100 phr of at least one carbon black.

The silicas may be silicas known to those skilled in the art which are suitable as fillers for tire rubber mixtures. Preference is given to using a precipitated silica. Particular preference is given to using a finely divided precipitated silica having a nitrogen surface area (BET surface area) (in accordance with DIN ISO 9277 and DIN 66132) of from 35 to 400 m²/g, preferably from 35 to 350 m²/g, particularly preferably from 85 to 320 m²/g, and a CTAB surface area (in accordance with ASTM D 3765) of from 30 to 400 m²/g, preferably from 60 to 330 m²/g, particularly preferably from 80 to 300 m²/g.

If the rubber composition contains carbon black, all types of carbon black known to those skilled in the art are conceivable. However, preference is given to using a carbon black having an iodine adsorption number in accordance with ASTM D 1510 of from 30 to 250 g/kg, preferably from 30 to 180 kg/g, and a DBP number in accordance with ASTM D 2414 of from 80 to 200 mL/100 g, preferably from 100 to 200 m L/100 g, particularly preferably from 115 to 200 m L/100 g.

The rubber composition of the invention may also comprise a mixture of two or more of the fillers mentioned.

Silane coupling reagents may be used as adhesion promoters between inorganic materials, for example with glass beads, glass shards, glass surfaces, glass fibers, or oxidic fillers, preferably silicas, and organic polymers, for example thermosets, thermoplastics or elastomers, or as crosslinking agent and surface modifier for oxidic surfaces.

Silane coupling agents that may be used here include any silane coupling agents known to those skilled in the art for use in rubber mixtures. Such coupling agents known from the prior art are bifunctional organosilanes having at least one alkoxy, cycloalkoxy or phenoxy group as a leaving group on the silicon atom and having, as another functionality, a group that, after cleavage if necessary, can enter into a chemical reaction with the double bonds of the polymer. The latter group may for example comprise the following chemical groups: —SCN, —SH, —NH₂ or —Sx- (with x=2 to 8).

Carbon black coupling agents may also be used.

In the context of the present invention, zinc oxide does not count as one of the fillers, but may be present in the rubber composition, preferably in combination with stearic acid.

In addition, the rubber composition preferably also comprises further additives.

Further additives may essentially be—besides zinc oxide (ZnO) and stearic acid—plasticizers, vulcanization accelerators, antiozonants, further aging stabilizers, reinforcer resins including HMMM/HMT, tackifying resins, masticating aids, bonding systems, reinforcer resins and further activators or processing aids, for example fatty acid salts, for example zinc soaps, and fatty acid esters and derivatives thereof, for example zinc stearate, or zinc complexes, for example zinc ethylhexanoate.

Known plasticizers include aromatic, naphthenic or paraffinic mineral oil plasticizers, for example MES (mild extraction solvate) or RAE (residual aromatic extract) or TDAE (treated distillate aromatic extract), or rubber-to-liquid oils (RTL) or biomass-to-liquid oils (BTL) or factices or plasticizer resins or liquid polymers (such as liquid BR).

The proportion of the total amount of further additives is preferably 3 to 150 phr, preferably 3 to 100 phr and particularly preferably 5 to 100 phr.

The present invention further provides for the use of the described rubber composition for production of an elastic material, for example for production of rubber articles, such as bellows, conveyor belts, air springs, belts, drive belts, for example V-belts, toothed belts, flat belts, V-ribbed belts, hoses, footwear soles, rubber rings, tactile sensors for medical applications or robot applications, medical articles, tubing or in particular vehicle tires (including parts thereof). The invention thus also further provides an elastic material, the production of which involved the use of at least one rubber composition of the invention.

“Vehicle tires” are to be understood to mean pneumatic vehicle tires and solid rubber tires, including tires for industrial and construction site vehicles, truck tires, car tires and two-wheeled-vehicle tires. The rubber composition of the invention can also be used for production of certain parts of such tires, for example for production of the tread or a body mixture, including sidewall, inner liner, apex, belt, shoulder, squeegees, further inserts (e.g. runflat), belt profile, carcass, bead reinforcement and/or bandage.

### EXAMPLE 1: ADDITION OF VARIOUS AGING STABILIZERS

Various aging stabilizers, as shown in Table 1, were contacted with the natural rubber over an incubation time of 8 hours. The rubber produced was stored at 70° C. for up to 14 days. Stabilization against aging was determined in the rubber obtained by determining, by means of gel permeation chromatography, the number-average (Mₙ) and the weight-average (M_{w}) molecular weights of the natural rubber polymers, from which the polydispersity factor can be calculated. Comparing these values over time gives a measure of the aging of the rubber.

TABLE 1

| | 1 | 2 |
|---|---|---|
| | LNR (2) without aging | LNR (2) without aging |
| | stabilization | stabilization |
| Aging | fresh | 14 days/70° C. |
| Mn | 565 000 | 222 000 |
| Mw | 1 953 000 | 678 000 |
| PD (1) | 3.45 | 3.06 |
| Mn fresh/Mn 14 | | 2.55 |
| days/70° C. | | |

| | 3 | 4 |
|---|---|---|
| | LNR (2) with BHT | LNR (2) with BHT |
| Aging | fresh | 14 days/70° C. |
| Mn | 616 000 | 303 000 |
| Mw | 2 250 000 | 885 000 |
| PD (1) | 3.65 | 2.92 |
| Mn fresh/Mn 14 | | 2.03 |
| days/70° C. | | |

| | 5 | 6 |
|---|---|---|
| | LNR (2) with Wingstay | LNR (2) with Wingstay |
| Aging | fresh | 14 days/70° C. |
| Mn | 452 000 | 260 000 |
| Mw | 1 942 000 | 771 000 |
| PD (1) | 4.29 | 2.97 |
| Mn fresh/Mn 14 | | 1.74 |
| days/70° C. | | |

| | 7 | 8 |
|---|---|---|
| | IR (3) | IR (3) |
| Aging | fresh | 14 days/70° C. |
| Mn | 328 000 | 225 000 |
| Mw | 1 241 000 | 861 000 |
| PD (1) | 3.79 | 3.82 |
| Mn fresh/Mn 14 | | 1.46 |
| days/70° C. | | |

| | 9 | 10 |
|---|---|---|
| | NR (4) | NR (4) |
| Aging | fresh | 14 days/70° C. |
| Mn | 332 000 | 323 000 |
| Mw | 1 260 000 | 1 177 000 |
| PD (1) | 3.80 | 3.65 |
| Mn fresh/Mn 14 | | 1.03 |
| days/70° C. | | |

(1) polydispersity factor (M_{w}/Mn)
(2) LNR = natural rubber from dandelion, in this case Taraxacum kok-saghyz
(3) IR: synthetic rubber
(4) NR: natural rubber from Hevea brasiliensis

The degree of stabilization against aging was determined via the number-average molecular weight ratio Mn fresh/Mn 14 days at 70° C.:

### Results:

LNR without aging stabilization: 2.55: decrease in molecular weight, aging
LNR with BHT: 2.0: average aging
LNR with Wingstay®: 1.7: average aging
IR: 1.46: little aging
NR: 1.03: virtually no decrease in molecular weight, hardly any material aging

### EXAMPLE 2: QUALITY FEATURES OF AGING-RESISTANT NATURAL RUBBER COMPOSITIONS

The further ingredients shown in Table 3 were incorporated into the natural rubber compositions 1 to 6 produced according to Example 1 and into a natural rubber likewise admixed with a vitamin E derivative according to batches 11 and 12, in order to produce rubber compositions suitable for tire production. To this end, 100 parts by weight of each of the rubber compositions 1 to 6 and 11 and 12 (see Table 2) were admixed with the further constituents indicated in Table 3 (in parts by weight) and processed to form a rubber material:

TABLE 2
Batch No.

| | |
|---|---|
| 1. | LNR without aging stabilization, fresh |
| 2. | LNR without aging stabilization, aged for 14 days/70° C. |
| 3. | LNR with BHT, fresh |
| 4. | LNR with BHT, aged for 14 days/70° C. |
| 5. | LNR with Wingstay ®, fresh |
| 6. | LNR with Wingstay ®, aged for 14 days/70° C. |
| 11. | LNR with DMT3, fresh |
| 12. | LNR with DMT3, aged for 14 days/70° C. |

LNR = natural rubber from dandelion, in this case Taraxacum kok-saghyz

TABLE 3
Further ingredients of the rubber compositions,
each in (parts by weight)

| | |
|---|---|
| Carbon black (N 121) | 48.50 |
| DTPD | 1.00 |
| 6PPD | 1.50 |
| TMQ | 1.00 |
| Antiozonant wax | 2.50 |
| ZnO | 3.00 |
| Stearic acid | 2.00 |
| TBBS | 1.00 |
| Sulfur | 1.65 |

The results of the quality test and load test for the rubber compositions produced are shown in Table 4.

TABLE 4
Evaluation of the properties of the rubber compositions

| | | Batch No. | | | | | | | | |
|---|---|---|---|---|---|---|---|---|---|---|
| | Unit | 1 | 2 | 3 | 4 | 5 | 6 | 11 | 12 | Evaluation |
| Vulcanization | min | 5 | 5 | 5 | 5 | 5 | 5 | 5 | 5 | |
| time | | | | | | | | | | |
| Vulcanization | Celsius | 160 | 160 | 160 | 160 | 160 | 160 | 160 | 160 | |
| temperature | | | | | | | | | | |
| Shore A | | | | | | | | | | |
| hardness | | | | | | | | | | |
| Shore A | Shore | 72.1 | 74.3 | 69.5 | 73.1 | 71 | 75.2 | 72 | 69.7 | |
| hardness (RT) | A | | | | | | | | | |
| Δ Shore A | | | 2.2 | | 3.6 | | 4.2 | | −2.3 | |
| hardness after | | | | | | | | | | |
| aging (RT) | | | | | | | | | | |
| Shore A | Shore | 66 | 67 | 63.2 | 66.5 | 65.4 | 67.1 | 63.9 | 63.3 | |
| hardness | A | | | | | | | | | |
| (70° C.) | | | | | | | | | | |
| Δ Shore A | | | 1 | | 3.3 | | 1.7 | | −0.6 | |
| hardness after | | | | | | | | | | |
| aging (70° C.) | | | | | | | | | | |
| Rebound | | | | | | | | | | |
| elasticity | | | | | | | | | | |
| (resilience) | | | | | | | | | | |
| Resilience (RT) | % | 32.4 | 31 | 34.8 | 30.6 | 33.8 | 31.3 | 31.5 | 33.2 | |
| Resilience | % | 48.3 | 44.5 | 51.1 | 45.6 | 49.3 | 46.7 | 46.3 | 48.4 | |
| (70° C.) | | | | | | | | | | |
| Δ resilience | | | −3.8 | | −5.5 | | −2.6 | | 2.1 | |
| after aging | | | | | | | | | | |
| (70° C.) | | | | | | | | | | |
| Diff(Rb 70° C. − | % | 15.9 | 13.5 | 16.3 | 15.1 | 15.5 | 15.4 | 14.9 | 15.1 | (A) |
| Rb RT) | | | | | | | | | | |
| Stress value | | | | | | | | | | |
| (modulus) RT | | | | | | | | | | |
| (S3) | | | | | | | | | | |
| M100 (RT) (S3) | MPa | 3 | 3 | 3 | 3.6 | 2.9 | 3 | 2.8 | 2.5 | |
| M200 (RT) (S3) | MPa | 7.9 | 7.3 | 7.4 | 8.7 | 7.8 | 7.4 | 7 | 6.4 | |
| M300 (RT) (S3) | MPa | 14 | 12.6 | 12.9 | 14.1 | 13.5 | 12.5 | 11.7 | 11.2 | |
| M300/M100 | | 4.67 | 4.20 | 4.30 | 3.92 | 4.66 | 4.17 | 4.18 | 4.48 | |
| Δ after aging | | | −0.47 | | −0.38 | | −0.49 | | 0.30 | |
| (RT) | | | | | | | | | | |
| Tensile | MPa | 21.2 | 18.9 | 21.5 | 20.4 | 21.3 | 19.1 | 18.9 | 17.4 | |
| strength (RT) | | | | | | | | | | |
| (S3) length | | | | | | | | | | |
| Δ tensile | | | −2.3 | | −1.1 | | −2.2 | | −1.5 | (B) |
| strength after | | | | | | | | | | |
| aging (RT) | | | | | | | | | | |
| Elongation at | % | 440 | 438 | 466 | 430 | 458 | 445 | 462 | 442 | |
| break (RT) (S3) | | | | | | | | | | |
| length | | | | | | | | | | |
| Δ elongation at | | | −2 | | −36 | | −13 | | −20 | |
| break after | | | | | | | | | | |
| aging (RT) | | | | | | | | | | |
| Fracture | J/cm³ | 42.7 | 38.5 | 45.8 | 42.3 | 45.2 | 39.9 | 40.9 | 34.8 | |
| energy | | | | | | | | | | |
| density (S3) | | | | | | | | | | |
| length | | | | | | | | | | |
| Δ fracture | | | −4.2 | | −3.5 | | −5.3 | | −6.1 | (C) |
| energy density | | | | | | | | | | |
| after aging (RT) | | | | | | | | | | |
| Abrasion | | | | | | | | | | |
| Abrasion (RT) | mm³ | 182 | 198 | 171 | 187 | 196 | 190 | 184 | 190 | |
| Δ abrasion after | | | | | | | | | | (D) |
| aging (RT) | | | 16 | | 16 | | −6 | | 6 | |

Table data: methods of determination
Shore A hardness at room temperature and 70° C. using a durometer in accordance with DIN ISO 7619-1 [Shore A]
Rebound elasticity at room temperature and 70° C. in accordance with DIN 53 512 or ISO 4662 or ASTM D 1054 [%]
Stress value (modulus) at 100%, 200% and 300% elongation at room temperature in accordance with DIN 53 504 [MPa]
Tensile strength at room temperature in accordance with DIN 53 504 [MPa]
Elongation at break at room temperature in accordance with DIN 53504 [%]
Fracture energy density determined in a tensile test in accordance with DIN 53 504, the fracture energy density being the work required for fracture, based on the volume of the specimen [J/cm³]
Abrasion at room temperature in accordance with DIN 53 516 or new DIN/ISO 4649 [mm³]

The results of the quality test show that the addition of aging stabilizers to the natural rubber composition has a positive influence not only on the aging of the natural rubber, but also on the properties of the rubber produced from this material.

Regarding the evaluation in Table 4:
(A) a smaller drop in difference in rebound elasticity provides advantages in the trade-off between rolling resistance and wet grip of a vehicle tire
(B) the smaller the drop in tensile strength after aging, the better the durability
(C) the smaller the drop in fracture energy density after aging, the better the durability
(D) the lower the DIN abrasion after aging, the longer the life of a tire.

1-13. (canceled)

14. A method for obtaining aging-resistant natural rubber, the method comprising:
(I) providing a plant material comprising a polymer-containing sap, wherein the polymer-containing sap contains at least natural polyisoprenes,
(II) treating the plant/the plant material in such a way that the sap and/or its ingredients is separated from the remaining plant tissue,
(III) contacting the plant material/the polymer-containing sap and/or its ingredients with at least one aging stabilizer,
(IV) coagulating and/or agglomerating the natural polyisoprenes to afford natural rubber flakes,
(V) optionally washing the natural rubber flakes,
(VI) obtaining the natural rubber flakes from the extract/the washing solution,
(VII) optionally drying the natural rubber
(VIII) optionally incorporating the aging stabilizer into the natural rubber, wherein the contacting of the aging stabilizer according to step (III) is carried out before or at the latest during the drying of the natural rubber.

15. The method of claim 14, wherein the method is carried out with fresh and or stored but not separately dried plant material.

16. The method of claim 14, wherein (III) is carried out before, during or after step (II), before, during or after step (IV), and/or before or during step (V), but in any case before or at the latest during step (VII).

17. The method of claim 14, wherein the polymer-containing sap and/or its ingredients is/are extracted from at least one plant material selected from a Taraxacum sp. or Scorzonera sp., especially from Russian dandelion, such as Taraxacum kok-saghyz, Taraxacum krim-saghyz, Taraxacum bicorne, Taraxacum brevicorniculatum, or from Scorzonera tau-saghyz, Scorzonera uzbekistanica, Scorzonera taka-saghyz, Scorzonera hispanica, Scorzonera tau-saghyz, or mixtures of these plants, preferably from Taraxacum kok-saghyz, Scorzonera tau-saghyz, Scorzonera uzbekistanica, Scorzonera teke-saghyz or mixtures or natural or cultivated hybrids thereof, further preferably at least from Taraxacum kok-saghyz, Taraxacum krim-saghyz or mixtures thereof or hybrids with involvement thereof, particularly preferably at least from Taraxacum kok-saghyz.

18. The method of claim 14, wherein the aging stabilizer is selected from butylated hydroxytoluene (BHT), vitamin E in at least one stereoisomeric form or a derivative thereof, an N—C₁₋₁₂-alkyl-N′-phenyl-p-phenylenediamine, such as N-isopropyl-N′-phenyl-p-phenylenediamine, N-1,3-dimethylbutyl-N′-phenyl-p-phenylenediamine (6PPD), N-1,4-dimethylpentyl-N′-phenyl-p-phenylenediamine (7PPD) or N,N′-bis-1,4-(1,4-dimethylpentyl)-p-phenylenediamine (77PD), diaryl-p-phenylenediamine (DTPD), 4,4′-bis(C₁₋₁₂-alkylamino)triphenylamine, 7,8-dimethylisoalloxazine or a compound containing 7,8-dimethylisoalloxazine as a structural building block, such as riboflavin, p-phenylenediamine, p-di(nitroso)arenes, such as poly-p-di(nitroso)benzene, oligomerized 2,2,4-trimethyl-1,2-dihydroquinoline (TMQ), styrenated diphenylamine (DDA), cumylated diphenylamine, zinc salt of 4- and 5-methylmercaptobenzimidazole, 2,6-di-tert-butylphenol, 2,6-di-tert-butyl-4-ethylphenol, 2,2′-methylenebis(6-tert-butyl)-p-cresol, poly(dicyclopentadiene-co-p-cresol), n-octadecyl beta-(4-hydroxy-3,5-di-tert-butylphenyl)propionate, 2,2′-methylenebis(4-methyl-6-tert-butylphenol) (BPH), 2-methyl-4,6-bis(octylsulfanylmethyl)phenol, thiobisphenols, 4,4′-bis(1,1-dimethylbenzyl)diphenylamine (CDPA), octylated diphenylamine (ODPA), phenyl-a-naphthylamine (PAN), phenyl-beta-naphthylamine (PBN), tris(nonylphenyl)phosphite, sodium hypophosphite, 2,2,4-trimethyl-1,2-dihydroquinoline (TMQ), 2-mercaptobenzimidazole (MBI), methyl-2-mercaptobenzimidazole (MMBI), or any combination of the foregoing, preference being given to the aging stabilizers selected from butylated hydroxytoluene (BHT), vitamin E in the form of a tocopherol or a tocotrienol, the zinc salt of di-n-butyldithiocarbamic acid, and a mixture of butylated reaction products of p-cresol and dicyclopentadiene according to formula (I) with n=1, 2, 3, 4, 5, 6, 7, 8 or 9, 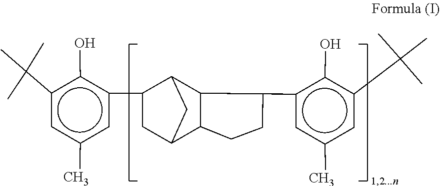
particular preference being given to using at least butylated hydroxytoluene (BHT) as aging stabilizer.

19. The method of claim 14, wherein the plant material comprises at least Russian dandelion, in particular Taraxacum kok-saghyz, and at least one aging stabilizer is selected from BHT, vitamin E or a derivative thereof and a compound according to formula (I) with n=1, 2, 3, 4, 5, 6, 7, 8 or 9.

20. The method of claim 14, wherein the aging stabilizer(s) is/are added to the plant material/the polymer-containing sap and/or its ingredients in an amount such that it is/they are present in the natural rubber obtained in a total amount of at least 0.01 phr, preferably in an amount of from 0.05 to 5 phr, further preferably from 0.10 to 3.5 phr, particularly preferably from 0.25 to 2 phr, most preferably from 0.4 to 1 phr.

21. The method of claim 14, wherein the aging stabilizer is added in the form of a powder, a suspension, a liquid or a solution to the plant material/the polymer-containing sap and/or its—optionally purified—ingredients.

22. The method of claim 14, wherein the contacting of the aging stabilizer into the natural rubber occurs under at least one of the following conditions:
(i) at a temperature of from −25° C. to 100° C., preferably in the range from 0° C. to 90° C., particularly preferably from 10° C. to 80° C.
(ii) by mechanical agitation, preferably stirring, rolling, milling or kneading or a combination thereof, or by diffusion in a suspension of rubber and aging stabilizer in water
(iii) for a period of at least 10 min, preferably at least 30 min, further preferably at least 1 hour.

23. The method of claim 14, further producing a rubber composition containing the natural rubber.

24. The method of claim 23, wherein the rubber composition additionally comprises at least one of the following additives:
(i) further types of rubber selected from natural rubber or synthetic rubber
(ii) fillers, preferably carbon black and/or silica
(iii) plasticizers
(iv) activators
(v) adhesives
(vi) pigments
(vii) vulcanization accelerators
(viii) vulcanization retarders
(ix) further crosslinking agents
(x) other admixtures.

25. The method of claim 24 further comprising producing rubber articles using the rubber composition.

26. The method of claim 25, wherein the rubber article is selected from tires, in particular vehicle tires, or tire parts, bellows, conveyor belts, air springs, belts, drive belts, such as V-belts, toothed belts, flat belts, V-ribbed belts, hoses, footwear soles, rubber rings, medical articles or tubing.
